(19) United States
(12) Patent Application Publication
(10) Pub. No.: US 2004/0238472 A1
(43) Pub. Date: Dec. 2, 2004

(54) Crane

(76) Inventors: Erik Varildengen, Oslo (NO); Lasse Petter Carlsen, Oslo (NO); Arthur Charles Ronnestad, Oslo (NO)

Correspondence Address: William P. Wilbar, Sierra Patent Group, PO Box 6149, Stateline, NV, 89449, US

(21) Appl. No.: 10/493,931

(22) PCT Filed: Oct. 24, 2002
(86) PCT No.: PCT/NO02/00385

(30) Foreign Application Priority Data
Oct. 25, 2001 (NO) 20015216

(51) Int. Cl. B66C 23/18

(52) U.S. Cl. 212/179

(57) ABSTRACT

A crane for installation in window openings, on landings, truck bodies, shells of buildings etc., where a crane jib is equipped with bearing means for rotatable co-operation with a pivot arranged on a fixed part of a fixing bracket and at least one movable part of the fixing bracket, which movable part is designed to be fastened to the fixed part.

### CROSS-REFERENCE TO RELATED APPLICATIONS

This application claims filing date priority benefit to Norwegian Patent Application No. 2001 5216 filed Oct. 25, 2001, and to PCT Application No. PCT/NO02/00385 filed Oct. 24, 2002, under 35 U.S.C. 119, which is explicitly incorporated by reference as if set forth below.

### BACKGROUND

The present invention regards a fastening device for a crane of the type indicated in the introduction to claim 1.

In the building business, it is often necessary to transfer goods such as bags, materials etc. from a transport vehicle to a building site, which may be a flat in a block of flats. Up until now, this has normally been carried out through manual carrying, by use of a mobile lifting crane that hoists the goods up to a window in the flat, or an elevator moving along a ladder-like rail.

Carrying is hard work and takes a disproportionate amount of time. A mobile lifting crane must normally be booked in advance if the building contractor carrying out the job does not have such equipment at his disposal. The booking of a lifting crane may be difficult to fit into the delivery schedule for the goods. Normally, small building contractors do not have the financial means to buy a mobile lifting crane. An elevator takes time to install, and is not very flexible.

Thus in light of the above, there is a need for a simple crane that may readily and in an unproblematic manner be assembled anywhere in order to hoist goods up to a window, a landing etc., and which is not expensive to purchase.

The above is provided through a device of the type mentioned by way of introduction, the characteristics of which appear from claim 1. Further characteristics of the invention appear from the remaining, dependent claims.

Thus provision is made for simple installation of a crane by applying the principles of a fastening method that in itself has been much used in connection with desk lamps.

### BRIEF DESCRIPTION OF THE FIGURES

In the following, the invention will be described in greater detail with reference to the drawings, in which:

FIG. 1 schematically shows a crane with a fixing bracket where the components have been moved apart;

FIG. 2 shows the crane on the fixing bracket when the fixing bracket has been installed vertically relative to FIG. 1;

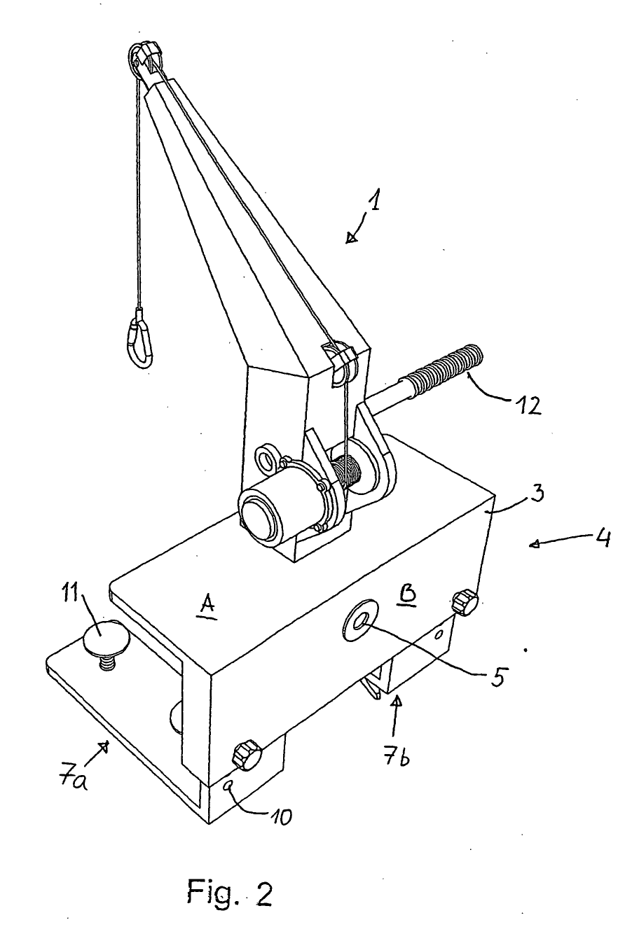

FIG. 3 shows the adjustment of the fixing bracket for different thicknesses of the fastening point; and

FIG. 4 shows a section through the crane.

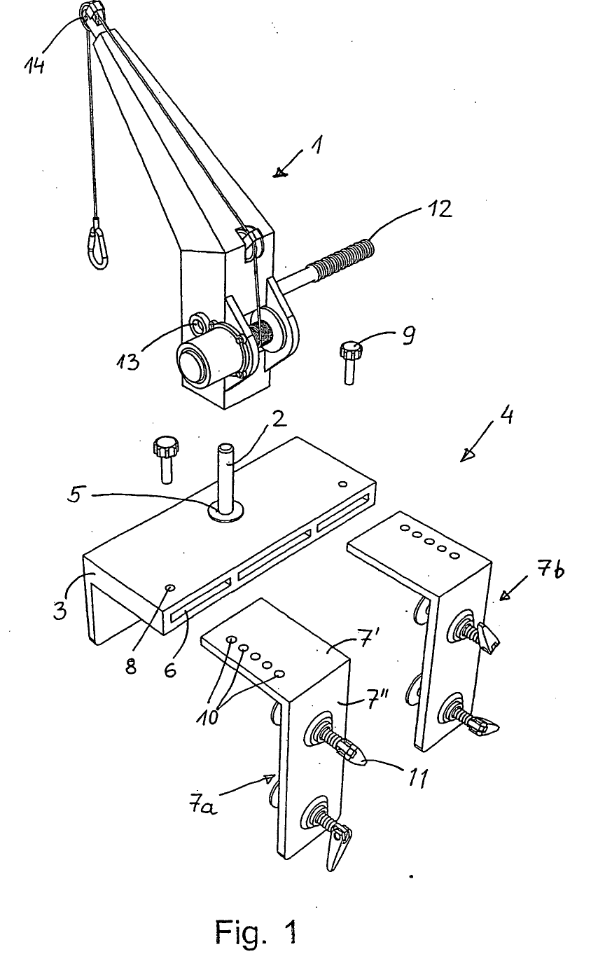

FIG. 1 shows a crane 1 that can be lowered onto a pivot 2 on one side of the fixed part 3 of a fixing bracket 4. The fixed part 3 is L-shaped, exhibiting in its central surface areas A and B a threaded hole 5, 5′ for placement of a pivot 2 onto which the crane 1 may be placed, with the crane being rotatable about this pivot 2. Whether the pivot 2 should be placed in the hole 5′ in area A or in the hole 5 in area B depends on which of the areas A, B is horizontal upon fastening of the fixing bracket 4.

The fixing bracket 4 consists of the L-shaped fixed part 3 and two L-shaped moving parts (locking elements) 7a and 7b that may be attached to the fixed part 3 by inserting them into pocket shaped openings 6 in one of the long sides of the fixed part, the openings 6 being of a dimension that corresponds to one of the legs 7′ of the L-shaped locking elements 7a and 7b. The leg 7′ has holes 10 that coincide with holes 8 in area B, so that when the leg 7′ is pushed into the opening 6 and one of the holes 10 is positioned over the hole 8 in area B of the L-shaped fixed part, the parts 3 and 7a, 7b may be locked together by inserting a locking bolt 9 down through the holes 8, 10.

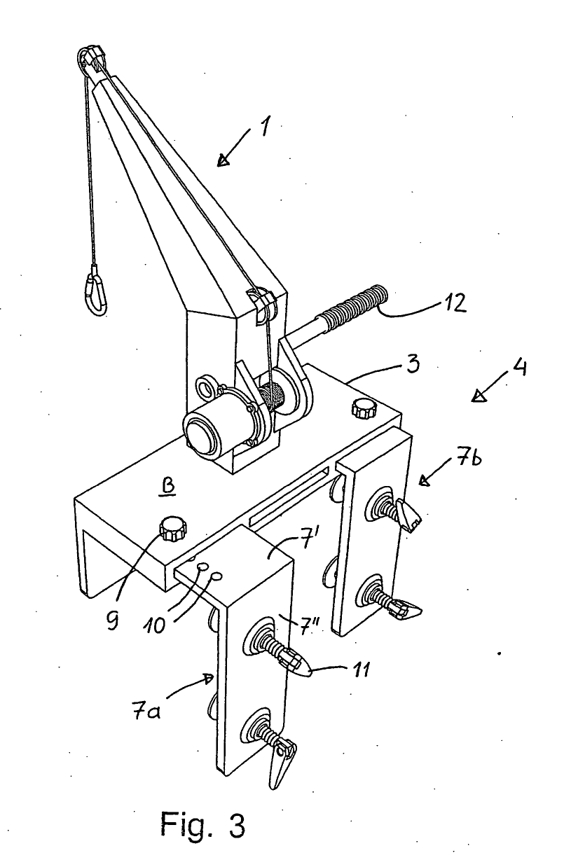

In the example shown, the fixing bracket 4 is equipped with two locking elements 7a and 7b. The leg 7′ of the locking elements 7a and 7b is executed with several holes 10 so that the distance between the leg 7″ of the locking elements 7a and 7b and the opposite part of the L-shaped fixed part 3 may be varied according to the thickness of the element to which the fixing bracket 4 is to be attached, e.g. the window sill. The use of two locking elements makes it possible to offset unequal thicknesses in the fastening area, cf. FIG. 3

The fixing bracket 4 is attached firmly to the fastening area, which may be e.g. a window sill, by tightening clamping screws 11 in the leg 7″ of the moving parts 7a and 7b and forcing clamping faces provided at the ends of the screws in towards the fastening area in the same manner as for a fastening device that is known per se, e.g. for a desk lamp. Optionally, intermediate shims in the form of pieces of wood may be placed in between.

The handle for turning the crane 1 is constituted by a rod 12 that may be arranged on either side of the crane jib. The rod 12 is inserted into a threaded hole 13 in the crane jib.

Preferably, the crane is equipped with an electric motor having the appropriate control electronics. Optionally, the motor may be replaced with a geared crank.

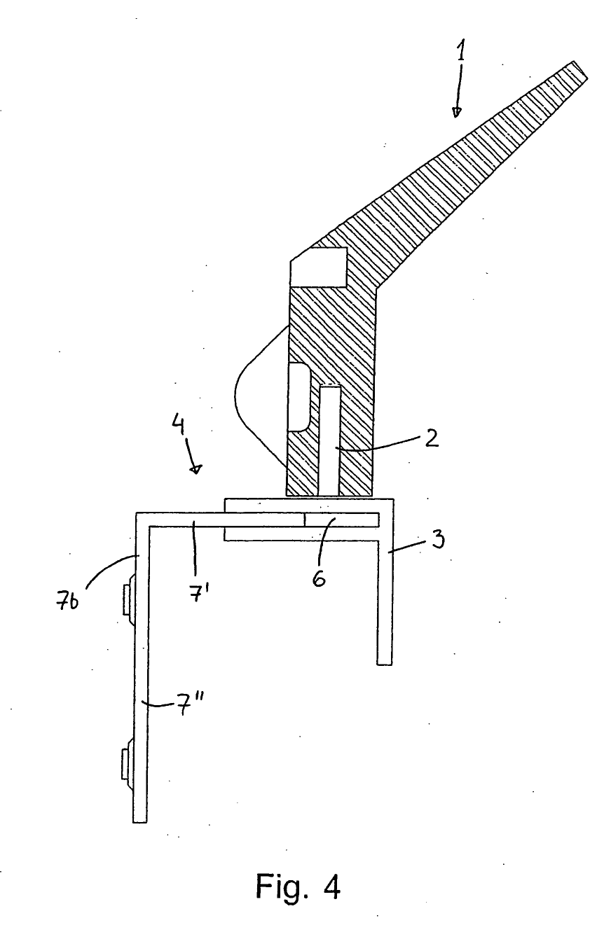

In the example shown, the crane may be rotated through 360 ∞ about the pivot 2 upon co-operation with a socket at the bottom of the crane 1, cf. FIG. 4. Furthermore, the pivot 2 may be moved from one area to the other area of the L-shaped fixed part 3. Other forms of support are also possible, e.g. ball bearings to replace the socket.

The pulley 14 is rotatably arranged in the crane jib so that in the case of a crane 1 having been installed slightly askew, this can be countered by the pulley rotating relative to the crane jib.

The various components may be placed into a case or a chest, allowing the crane to be transported in a relatively small vehicle and be carried by one or two persons.

1. A crane for installation in window openings comprising:
a crane jib equipped with bearing means for rotatable coupling to a fixed part of a fixing bracket and at least one movable part of the fixing bracket, which movable part is designed to be attached to the fixed part.

2. A crane according to claim 1, wherein the fixed part is generally L-shaped.

3. A crane according to claim 2, wherein the bearing means comprises:
a pivot designed to be fastened to a central area of surfaces of the L-shaped fixed part.

4. A crane according to claim 3, wherein the L-shaped fixed part has pocket shaped openings in at least one of its long sides, the openings having dimensions that correspond to those of one leg of L-shaped movable parts.

5. A crane according to claim 4, wherein a leg of the L-shaped movable parts having holes defined in the leg that coincide with holes defined in the area of a portion of the fixed part that has pocket shaped openings to allow a leg of the movable parts to be pushed into the pocket shaped opening, the fixed part and the movable parts being locked together responsive to insertion of a locking bolt through the holes.
